(19) United States
(12) Patent Application Publication
(10) Pub. No.: US 2025/0121653 A1
(43) Pub. Date: Apr. 17, 2025

(54) SYSTEM AND METHOD OF CONTROLLING INTAKE RATE OF VEHICLE BLOWER

(71) Applicants: Hyundai Motor Company, Seoul (KR); Kia Corporation, Seoul (KR)

(72) Inventors: Ding Yuan FU, Yantai (CN); Xin LIU, Yantai (CN); Jingjing SHAO, Yantai (CN); Tae Hun JUNG, Seoul (KR); Hao FU, Yantai (CN)

(73) Assignees: Hyundai Motor Company, Seoul (KR); Kia Corporation, Seoul (KR)

(21) Appl. No.: 18/816,915

(22) Filed: Aug. 27, 2024

(30) Foreign Application Priority Data
Oct. 13, 2023 (CN) 202311332060.9

(51) Int. Cl. B60H 1/00

(52) U.S. Cl. CPC B60H 1/00821; B60H 1/00742; B60H 1/00764

(57) ABSTRACT

In a system and a method of controlling an intake rate of a vehicle blower, the system of controlling an intake rate of a vehicle blower includes: a blower step number detection device configured to detect a current step number of a blower; a vehicle velocity detection device configured to detect a current vehicle velocity of a vehicle; a passenger seat seating detection device configured to detect whether a passenger is seated on a passenger seat; and an HVAC control device electrically connected to each of the blower step number detection device, the vehicle velocity detection device, and the passenger seat seating detection device, and configured to receive information from the passenger seat seating detection device, the vehicle velocity detection device, and the blower step number detection device, and to determine whether an intake rate control of the blower is turned on or off according to the current step number of the blower, the current vehicle velocity, and the passenger seat seating information when the blower is turned on as the vehicle is started.

### CROSS-REFERENCE TO RELATED APPLICATION

The present application claims priority to Chinese Patent Application No. 202311332060.9 filed in the Chinese National Intellectual Property Administration on Oct. 13, 2023, the entire contents of which is incorporated herein for all purposes by this reference.

### BACKGROUND OF THE PRESENT DISCLOSURE

### Field of the Present Disclosure

The present disclosure relates to a control technology field of a vehicle, and particularly, to a system and a method of controlling an intake rate of a vehicle blower.

### Description of Related Art

With supply of electric vehicles, electric vehicles without an automatic defogging sensor (ADS) are popular due to low prime cost compared to electric vehicles with the ADS. However, in the case of the electric vehicles without the ADS, power consumption of a positive temperature coefficient (PTC) element is increased due to heating of the PTC element in a low temperature environment, and all electric range (AER) of the electric vehicle is decreased. Furthermore, in the case of the electric vehicle without the ADS, when a vehicle velocity is high and a blower step number is low, a suction pressure of the blower is low, so external cold air is introduced into the vehicle, and this may lower a temperature of a foot region and a temperature of a head region of a driver on a front seat. Furthermore, because the electric vehicle without the ADS cannot sense external temperature and humidity information of the vehicle, an intake rate of the blower cannot be controlled according to a change of an external environment, so fogging is easily generated on a front window.

Therefore, in the case of the electric vehicle without the ADS, a system and a method that can intelligently control the intake rate of the vehicle blower is desperately needed.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to determining whether control of an intake rate of a blower is turned on by obtaining passenger seating information of a passenger seat, vehicle velocity information, and a blower step number of an electric vehicle without an ADS to reduce power consumption of a positive temperature coefficient (PTC) element, increase a winter-season all electric range (AER) of the electric vehicle, and driving and boarding comfort of a driver and a passenger.

An exemplary embodiment of the present disclosure provides a system of controlling an intake rate of a vehicle blower. The system may include: a blower step number detection device configured to detect a current step number of a blower; a vehicle velocity detection device configured to detect a current vehicle velocity of a vehicle; a passenger seat seating detection device configured to detect whether a passenger is seated on a passenger seat; and a Heating, Ventilation, and Air Conditioning (HVAC) control device electrically connected to each of the blower step number detection device, the vehicle detection device, and the passenger seat seating detection device, and configured to receive information from the passenger seat seating detection device, the vehicle velocity detection device, and the blower step number detection device, and to determine whether an intake rate control of the blower is turned on or off according to the current step number of the blower, the current vehicle velocity, and the passenger seat seating information when the blower is turned on as the vehicle is started.

The step number of the blower may include a plurality of step numbers, and the HVAC control device is further configured to turn off an intake rate control function of the blower when the detected current blower step number is a predetermined step number, and turn on the intake rate control function of the blower when the detected current blower step number is a step number other than the predetermined step number among the plurality of step numbers.

The HVAC control device may include a memory, the memory stores a predetermined intake rate control mapping table based on the vehicle velocity information and the blower step number, and the intake rate control mapping table is divided into an intake rate control ON area and an intake rate control OFF area, and the memory further stores a predetermined first intake rate control switching delay time and a predetermined second intake rate control switching delay time. The HVAC control device may be further configured to determine whether a current intake rate control state is at the intake rate control ON area or the intake rate control OFF area based on the intake rate control mapping table according to the current vehicle velocity and the current blower step number in a state of concluding that the intake rate control function of the blower is turned on, and determine a change of the current intake rate control state between the intake rate control ON area and the intake rate control OFF area.

The HVAC control device may be further configured to, when determining that the current intake rate control state is changed from the intake rate control ON area to the intake rate control OFF area in a state of concluding that the passenger is seated on the passenger seat, determine whether a time for which the current intake rate control state is maintained at the intake rate control OFF area is equal to or greater than the first intake rate control switching delay time, when the time for which the current intake rate control state is maintained at the intake rate control OFF area is equal to or greater than the first intake rate control switching delay time, change the intake rate control to OFF, and when the time for which the current intake rate control state is maintained at the intake rate control OFF area is less than the first intake rate control switching delay time, maintain the intake rate control to ON.

The HVAC control device may be further configured to, when determining that the current intake rate control state is changed from the intake rate control OFF area to the intake rate control ON area, determine whether the time for which the current intake rate control state is maintained at the intake rate control ON area is equal to or greater than the first intake rate control switching delay time, when the time for which the current intake rate control state is maintained at the intake rate control ON area is equal to or greater than the first intake rate control switching delay time, change the intake rate control to ON, and when the time for which the current intake rate control state is maintained at the intake rate control ON area is less than the first intake rate control switching delay time, maintain the intake rate control to OFF.

The HVAC control device may be further configured to, when determining that the current intake rate control state is changed from the intake rate control ON area to the intake rate control OFF area in a state of concluding that the passenger is not seated on the passenger seat, determine whether the time for which the current intake rate control state is maintained at the intake rate control OFF area is equal to or greater than the second intake rate control switching delay time, when the time for which the current intake rate control state is maintained at the intake rate control OFF area is equal to or greater than the second intake rate control switching delay time, change the intake rate control to OFF, and when the time for which the current intake rate control state is maintained at the intake rate control OFF area is less than the second intake rate control switching delay time, maintain the intake rate control to ON.

The HVAC control device may be further configured to, when determining that the current intake rate control state is changed from the intake rate control OFF area to the intake rate control ON area, determine whether the time for which the current intake rate control state is maintained at the intake rate control ON area is equal to or greater than the first intake rate control switching delay time, when the time for which the current intake rate control state is maintained at the intake rate control ON area is equal to or greater than the first intake rate control switching delay time, change the intake rate control to ON, and when the time for which the current intake rate control state is maintained at the intake rate control ON area is less than the first intake rate control switching delay time, maintain the intake rate control to OFF.

Turning on the intake rate control may be to make a recirculation intake rate of the blower reach a predetermined ratio, and the predetermined ratio is 30% of a total intake amount, and turning off the intake rate control may be to make a recirculation intake rate of the blower reach 0.

The predetermined step number may be 1st step.

The first intake rate control switching delay time is set to 10 seconds, and the second intake rate control switching delay time is set to 70 seconds.

Another exemplary embodiment of the present disclosure provides a method of controlling an intake rate of a vehicle blower. The method may include: detecting a step number of a blower; detecting a current vehicle velocity of a vehicle; detecting whether a passenger is seated on a passenger seat; and determining whether the intake rate control of the blower is turned on or off according to the current step number of the blower, the current vehicle velocity, and the passenger seat seating information when the blower is turned on as the vehicle is started.

The step number of the blower may include a plurality of step numbers, and the method may further include: turning off an intake rate control function of the blower when the detected current blower step number is a predetermined step number; and turning on the intake rate control function of the blower when the detected current blower step number is a step number other than the predetermined step number among the plurality of step numbers.

A predetermined intake rate control mapping table may be stored based on the vehicle velocity information and the blower step number, and the intake rate control mapping table may be divided into an intake rate control ON area and an intake rate control OFF area, and a predetermined first intake rate control switching delay time and a predetermined second intake rate control switching delay time are stored. The method may further include: determining whether a current intake rate control state is in the intake rate control ON area or the intake rate control OFF area based on the intake rate control mapping table according to the detected current vehicle velocity and the current blower step numbering in a state of concluding that the intake rate control function of the blower is turned on; and determining a change of the current intake rate control state between the intake rate control ON area and the intake rate control OFF area.

The method may further include: when determining that the current intake rate control state is changed from the intake rate control ON area to the intake rate control OFF area in a state of concluding that the passenger is seated on the passenger seat, determining whether a time for which the current intake rate control state is maintained at the intake rate control OFF area is equal to or greater than the first intake rate control switching delay time; when the time for which the current intake rate control state is maintained at the intake rate control OFF area is equal to or greater than the first intake rate control switching delay time, changing the intake rate control to OFF; and when the time for which the current intake rate control state is maintained at the intake rate control OFF area is less than the first intake rate control switching delay time, maintaining the intake rate control to ON.

The method may further include: when determining that the current intake rate control state is changed from the intake rate control OFF area to the intake rate control ON area, determining whether the time for which the current intake rate control state is maintained at the intake rate control ON area is equal to or greater than the first intake rate control switching delay time; when the time for which the current intake rate control state is maintained at the intake rate control ON area is equal to or greater than the first intake rate control switching delay time, changing the intake rate control to ON; and when the time for which the current intake rate control state is maintained at the intake rate control OFF area is less than the first intake rate control switching delay time, maintaining the intake rate control to OFF.

The method may further include: when determining that the current intake rate control state is changed from the intake rate control ON area to the intake rate control OFF area in a state of concluding that the passenger is not seated on the passenger seat, determining whether the time for which the current intake rate control state is maintained at the intake rate control OFF area is equal to or greater than the second intake rate control switching delay time; when the time for which the current intake rate control state is maintained at the intake rate control OFF area is equal to or greater than the second intake rate control switching delay time, changing the intake rate control to OFF; and when the time for which the current intake rate control state is maintained at the intake rate control OFF area is less than the second intake rate control switching delay time, maintaining the intake rate control to ON.

The method may further include: when determining that the current intake rate control state is changed from the intake rate control OFF area to the intake rate control ON area, determining whether the time for which the current intake rate control state is maintained at the intake rate control ON area is equal to or greater than the first intake rate control switching delay time; when the time for which the current intake rate control state is maintained at the intake rate control ON area is equal to or greater than the first intake rate control switching delay time, changing the intake rate control to ON; and when the time for which the current intake rate control state is maintained at the intake rate control ON area is less than the first intake rate control switching delay time, maintaining the intake rate control to OFF.

Turning on the intake rate control may be to make a recirculation intake rate of the blower reach a predetermined ratio, and the predetermined ratio is 30% of a total intake amount, and turning off the intake rate control is to make the recirculation intake rate of the blower reach 0.

The predetermined step number is 1^{st} step.

The first intake rate control switching delay time may be set to 10 seconds, and the second intake rate control switching delay time may be set to 70 seconds.

The present disclosure adopts the technical method and provides the following beneficial effects.

In the case of the electric vehicle without the ADS, the map of the reference vehicle velocity and the blower step number of the vehicle is obtained, and whether the control of the intake rate is turned on/off is determined according to the seating situation of the passenger seat, so that the power consumption of the PTC is reduced and the AER of winter season is increased by maximally using a smart intake logic.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a schematic view of an intake port of a vehicle blower.

FIG. 2 is a block diagram of a system of controlling an intake rate of a vehicle blower according to an exemplary embodiment of the present disclosure.

FIG. 3 is a flowchart of a method of controlling an intake rate of a vehicle blower according to an exemplary embodiment of the present disclosure.

FIG. 4 is a flowchart of a process of turning on an intake rate control function in a method of controlling an intake rate of a vehicle blower according to an exemplary embodiment of the present disclosure.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes will be determined in part by the particularly intended application and use environment.

In the figures, reference numbers refer to the same or equivalent portions of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Hereinafter, an exemplary embodiment of the present disclosure will be described in detail, and the exemplary embodiment of the present disclosure will be conducted on the premise of the technical measure of the present disclosure, and a detailed implementation method and a specific operation process are presented, but the protection scope of the present disclosure is limited to the following exemplary embodiment of the present disclosure.

Hereinafter, an exemplary embodiment of the present disclosure will be described in detail with reference to drawings.

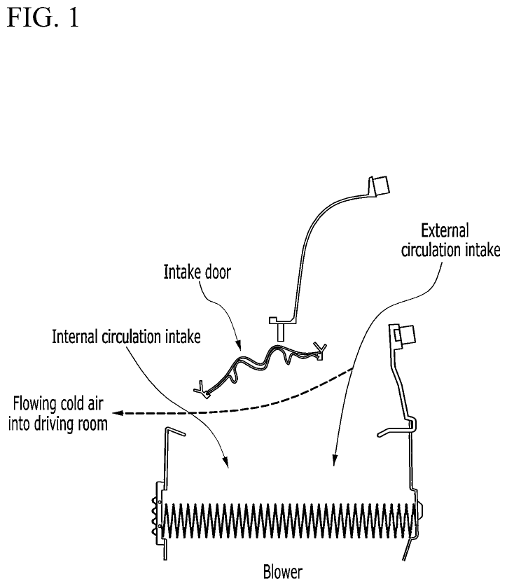

FIG. 1 is a schematic view of an intake port of a vehicle blower. Referring to FIG. 1, an intake rate at external circulation and an intake rate at internal circulation may be controlled by controlling an opening level of an intake door of the blower. Here, the internal circulation means that the blower draws and pressurizes in-vehicle air to be circulated in a vehicle, and the external circulation means that out-vehicle air is drawn in and the in-vehicle air is blown to an outside of the vehicle by pressure to implement a continuous interaction between fresh air and in-vehicle hazy air.

When a vehicle velocity is high and a blower step number is low in a low-temperature environment, a suction pressure of the blower is low, so external cold air flows into a driving room (marked by a dotted arrow “X” in FIG. 1) to lower a temperature at a side foot region of a passenger and a temperature at a side head region of a driver. In the instant case, the intake rate at the external circulation and the intake rate at the internal circulation should be controlled, and for example, the control of the intake rate at the internal circulation should be reduced.

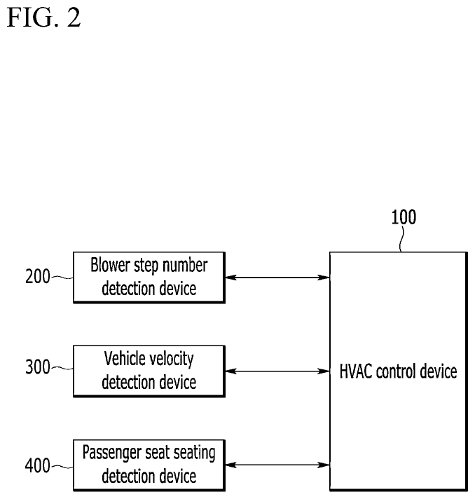

FIG. 2 is a block diagram of a system of controlling an intake rate of a vehicle blower according to an exemplary embodiment of the present disclosure. The system of controlling an intake rate of a vehicle blower according to an exemplary embodiment of the present disclosure includes a heating ventilation and air conditioning (HVAC) control device 100, a blower step number detection device 200, a vehicle velocity detection device 300, and a passenger seat seating detection device 400. The HVAC system provides desired heating, cooling, or ventilation to the driving room to maintain the temperature in the driving room of the vehicle at a fresh level to a driver and a passenger.

The blower step number detection device 200 may be configured to detect the step number of the blower. The blower may have a plurality of step numbers such as first step to eighth step. The higher the step number of the blower is, the larger a blowing amount is. For example, the step number of the blower may indicate the blowing amount of the blower. The vehicle velocity detection device 300 may be configured to detect a current vehicle velocity of the vehicle. The passenger seat seating detection device 400 may be configured to detect whether the passenger is seated on the passenger seat. The passenger seat seating detection device 400 is not limited to, but may include a seat pressure sensor, a safety belt sensor, etc. configured for sensing whether the passenger is seated on the passenger seat. The HVAC control device 100 may be electrically connected to each of the blower step number detection device 200, the vehicle velocity detection device 300, and the passenger seat seating detection device 400, and may be configured to receive information from the blower step number detection device 200, the vehicle velocity detection device 300, and the passenger seat seating detection device 400, and determine whether the control of the intake rate of the blower is turned on according to the detected current step number of the blower, the current vehicle velocity, and the passenger seat seating information when the blower is turned on as the vehicle is started.

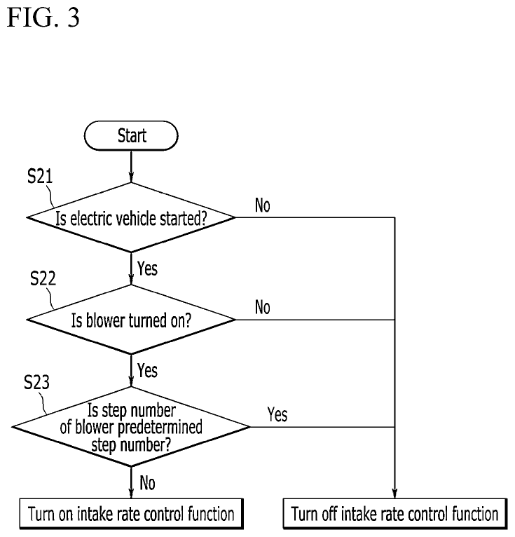

Hereinafter, an operation of the system of controlling an intake rate of a vehicle blower according to an exemplary embodiment of the present disclosure will be described in detail. FIG. 3 is a flowchart of a method of controlling an intake rate of a vehicle blower by the HVAC control device 100 according to an exemplary embodiment of the present disclosure.

In step S21, it is detected whether the electric vehicle is started, and in step S22, it is detected whether the blower is turned on. When the electric vehicle is started and the blower is turned on, it is detected whether the current blower step number is a predetermined step number in step S23. When the detected current blower step number is not the predetermined step number (i.e., when the detected current blower step number is a step number other than the predetermined step number among the plurality of step numbers), the HVAC control device may turn on an intake rate control function of the blower, and when the detected current blower step number is the predetermined step number, the HVAC control device may turn off the intake rate control function of the blower. The predetermined step number may be set to the first step, but the present disclosure is not limited thereto.

When the electric vehicle is not started or the blower is not turned on, the HVAC control device 100 turns off the intake rate control function of the blower.

According to an exemplary embodiment of the present disclosure, turning on the intake rate control function means further determining whether the control of the intake rate of the blower is turned on based on the detected current blower step number, the current vehicle velocity, and the passenger seat seating information. Turning off the intake rate control function means maintaining the existing intake rate control without conducting subsequent determination.

Hereinafter, a specific process of the turning on the intake rate control function in the method of controlling an intake rate of a vehicle blower according to an exemplary embodiment of the present disclosure will be described in detail.

According to an exemplary embodiment of the present disclosure, in a situation in which the intake rate control function is determined to be turned on, the HVAC control device 100 is configured to determine whether a current intake rate control state is in an intake rate control ON area or in an intake rate control OFF area based on an intake rate control mapping table according to the detected current vehicle velocity information and the current blower step number. The HVAC control device 100 is configured to determine whether the current intake rate control state is changed between the intake rate control ON area and the intake rate control OFF area, and then is additionally configured to determine whether the intake rate control of the blower is turned on based on whether the passenger is seated on the passenger seat and the change of the current intake rate control state between the intake rate control ON area and the intake rate control OFF area.

The HVAC control device 100 may include a processor and a memory, and the memory stores a predetermined intake rate control mapping table (shown in Table 1 below) based on the vehicle velocity information and the blower step number. The intake rate control mapping table is divided into the intake rate control ON area and the intake rate control OFF area. As shown in Table 1 below, symbol ‘⊚” represents the intake rate control ON area and symbol “X” represents the intake rate control OFF area.

TABLE 1

| | Vehicle velocity, V (KPH) | | | | | |
|---|---|---|---|---|---|---|
| Blower step | | 60 < | 70 < | 80 < | 90 < | |
| number | V ≤ 60 | V ≤ 70 | V ≤ 80 | V ≤ 90 | V < 100 | 100 |
| 8^{th} step | ⊚ | ⊚ | ⊚ | ⊚ | ⊚ | X |
| 7^{th} step | ⊚ | ⊚ | ⊚ | ⊚ | ⊚ | X |
| 6^{th} step | ⊚ | ⊚ | ⊚ | ⊚ | ⊚ | X |
| 5^{th} step | ⊚ | ⊚ | ⊚ | ⊚ | ⊚ | X |
| 4^{th} step | ⊚ | ⊚ | ⊚ | ⊚ | ⊚ | X |
| 3^{rd} step | ⊚ | ⊚ | ⊚ | ⊚ | X | X |
| 2^{nd} step | ⊚ | ⊚ | ⊚ | X | X | X |
| 1^{st} step | X | X | X | X | X | X |

When the blower step number is 1st step, the suction pressure of the blower is low and the external cold air easily flows into the driving room to lower the temperature at the side foot region of the passenger and the temperature at the side head region of the driver, referring back to FIG. 1. Because such a situation may cause inconvenience to the driver and the passenger, the intake rate control should be turned off. In the instant case, an internal circulation intake ratio of the blower is 0 and in the instant case, the power consumption of the PTC is also low. Similarly, when the vehicle velocity is 100 kph or more, the power consumption of the PTC is not low under a stable driving condition, so that the intake rate control should be turned off. As a result, the internal circulation intake ratio of the blower is 0.

According to an exemplary embodiment of the present disclosure, the turning on the intake rate control is to make the internal circulation intake ratio of the blower reach a predetermined ratio. The predetermined ratio may be set to 10%, 20%, 30%, 40%, 50%, etc. of the total intake amount. Furthermore, when reducing a cause such as a fogging risk of a vehicle window is considered, the predetermined ratio may be 30%. However, the present disclosure is not limited to such the predetermined ratios.

Accordingly, when the current vehicle velocity information and the current blower step number are detected, the HVAC control device 100 may be configured to determine whether the current intake rate control state is in the intake rate control ON area or the intake rate control OFF area based on the intake rate control mapping table, and determine the change of the current intake rate control state, i.e., whether the current intake rate control state is changed from the intake rate control ON area to the intake rate control OFF area or whether the current intake rate control state is changed from the intake rate control OFF area to the intake rate control ON area.

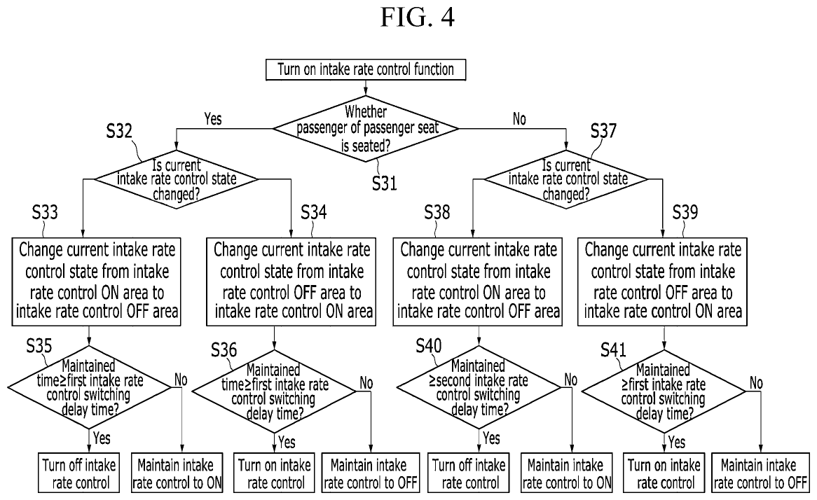

FIG. 4 is a flowchart of a process of turning on an intake rate control function in a method of controlling an intake rate of a vehicle blower according to an exemplary embodiment of the present disclosure.

Referring to FIG. 4, in step S31, the HVAC control device 100 is configured to determine whether the passenger is seated on the passenger seat based on the passenger seat seating information detected by the passenger seat seating detection device 400. The HVAC control device 100 is further configured to determine whether the control of the intake rate of the blower is turned on according to the change of the current intake rate control state based on whether the passenger is seated on the passenger seat.

When it is determined that the passenger is seated on the passenger seat (“Yes” in the step S31), the HVAC control device 100 determines whether the current intake rate control state is changed in step S32, that is, determines the current intake rate control state in real time based on the intake rate control mapping table and determines whether the current intake rate control state is changed, according to the current vehicle velocity information and the current blower step number.

When it is determined that the current intake rate control state is changed from the intake rate control ON area to the intake rate control OFF area in step S33, or it is determined that the current intake rate control state is changed from the intake rate control OFF area to the intake rate control ON area in step S34, the HVAC control device 100 is configured to determine whether a time for which the current intake rate control state is maintained is equal to or greater than a first intake rate control switching delay time in S35.

In a state of concluding that the current intake rate control state is changed from the intake rate control ON area to the intake rate control OFF area, when the time for which the current intake rate control state is maintained at the intake rate control OFF area is equal to or greater than the first intake rate control switching delay time (i.e., “Yes” in step S35), the intake rate control is maintained to be OFF to prevent the temperature of the foot region of the passenger from being lowered. When the time for which the current intake rate control state is maintained at the intake rate control OFF area is less than the first intake rate control switching delay time (i.e., “No” in the step S35), the intake rate control is maintained to be ON. That is, when the current intake rate control state is not maintained for the first intake rate control switching delay time, but is changed, the intake rate control is not switched, but the state change and the maintenance time are determined again.

Similarly, in a state of concluding that the current intake rate control state is changed from the intake rate control OFF area to the intake rate control ON area, when the time for which the current intake rate control state is maintained at the intake rate control ON area is equal to or greater than the first intake rate control switching delay time (i.e., “Yes” in step S36), the intake rate control is made to be changed to ON to reduce the power consumption of the PTC. When the time for which the current intake rate control state is maintained at the intake rate control OFF area is less than the first intake rate control switching delay time (i.e., “No” in the step S36), the intake rate control is maintained to be OFF. That is, the switching is not conducted.

When it is determined that the passenger is not seated on the passenger seat (“No” in the step S31), it is determined whether the current intake rate control state is changed in step S37. When it is determined that the current intake rate control state is changed from the intake rate control ON area to the intake rate control OFF area in step S38, it is determined whether the time for which the current intake rate control state is maintained is equal to or greater than a second intake rate control switching delay time. When it is determined that the current intake rate control state is changed from the intake rate control OFF area to the intake rate control ON area in step S39, it is determined whether the time for which the current intake rate control state is maintained is equal to or greater than the first intake rate control switching delay time.

In a state of determining whether the current intake rate control state is changed from the intake rate control ON area to the intake rate control OFF area, when the time for which the current intake rate control state is maintained at the intake rate control OFF area is equal to or greater than the second intake rate control switching delay time (i.e., “Yes” in step S40), the intake rate control is changed to be OFF to prevent the temperature of the head region of the driver from being lowered. When the time for which the current intake rate control state is maintained at the intake rate control OFF area is less than the second intake rate control switching delay time (i.e., “No” in the step S40), the intake rate control is maintained to be ON, and the switching is not conducted.

Similarly, in the state of determining that the current intake rate control state is changed from the intake rate control OFF area to the intake rate control ON area, when the time for which the current intake rate control state is maintained at the intake rate control ON area is equal to or greater than the first intake rate control switching delay time (i.e., “Yes” in step S41), the intake rate control is made to be changed to ON to reduce the power consumption of the PTC. When the time for which the current intake rate control state is maintained at the intake rate control ON area is less than the first intake rate control switching delay time (i.e., “No” in the step S41), the intake rate control is maintained to be OFF. That is, the switching is not conducted.

According to an exemplary embodiment of the present disclosure, the first intake rate control switching delay time and the second intake rate control switching delay time may be predetermined and stored in the memory of the HVAC control device 100. When the passenger is seated on the passenger seat, the intake rate control OFF area may be maintained for 10 seconds, and then the temperature of the foot region of the passenger at the passenger seat may be significantly lowered. When the passenger is not seated on the passenger seat, the intake rate control OFF area may be maintained for 70 seconds, and then the temperature of the side head region of the driver may be significantly lowered. In one example, the first intake rate control switching delay time may be set to 10 seconds, and the second intake rate control switching delay time may be set to 70 seconds, but the present disclosure is not limited thereto.

According to an exemplary embodiment of the present disclosure, it is determined whether the intake rate control of the blower is turned on by obtaining the passenger seating information of the passenger seat, the vehicle velocity information, and the blower step number of the electric vehicle without an ADS to prevent the temperature of the foot region of the passenger at the front seat and the temperature of the head region of the driver from being lowered in a low-temperature environment, to enhance driving and boarding comfort of the driver and the passenger, and to increase a winter-season all electric range (AER) of the electric vehicle by reducing the power consumption of the positive temperature coefficient (PTC) element.

In various exemplary embodiments of the present disclosure, all possible combinations are not listed, but the representative aspects of the present disclosure are described, and the contents described in various exemplary embodiments of the present disclosure may be applied independently or in two or more combinations.

Furthermore, the term related to a control device such as “controller”, “control apparatus”, “control unit”, “control device”, “control module”, “control circuit”, or “server”, etc refers to a hardware device including a memory and a processor configured to execute one or more steps interpreted as an algorithm structure. The memory stores algorithm steps, and the processor executes the algorithm steps to perform one or more processes of a method in accordance with various exemplary embodiments of the present disclosure. The control device according to exemplary embodiments of the present disclosure may be implemented through a nonvolatile memory configured to store algorithms for controlling operation of various components of a vehicle or data about software commands for executing the algorithms, and a processor configured to perform operation to be described above using the data stored in the memory. The memory and the processor may be individual chips. Alternatively, the memory and the processor may be integrated in a single chip. The processor may be implemented as one or more processors. The processor may include various logic circuits and operation circuits, may be configured for processing data according to a program provided from the memory, and may be configured to generate a control signal according to the processing result.

The control device may be at least one microprocessor operated by a predetermined program which may include a series of commands for carrying out the method included in the aforementioned various exemplary embodiments of the present disclosure.

The aforementioned invention can also be embodied as computer readable codes on a computer readable recording medium. The computer readable recording medium is any data storage device that can store data which may be thereafter read by a computer system and store and execute program instructions which may be thereafter read by a computer system. Examples of the computer readable recording medium include Hard Disk Drive (HDD), solid state disk (SSD), silicon disk drive (SDD), read-only memory (ROM), random-access memory (RAM), CD-ROMs, magnetic tapes, floppy discs, optical data storage devices, etc and implementation as carrier waves (e.g., transmission over the Internet). Examples of the program instruction include machine language code such as those generated by a compiler, as well as high-level language code which may be executed by a computer using an interpreter or the like.

In various exemplary embodiments of the present disclosure, each operation described above may be performed by a control device, and the control device may be configured by a plurality of control devices, or an integrated single control device.

In various exemplary embodiments of the present disclosure, the memory and the processor may be provided as one chip, or provided as separate chips.

In various exemplary embodiments of the present disclosure, the scope of the present disclosure includes software or machine-executable commands (e.g., an operating system, an application, firmware, a program, etc.) for enabling operations according to the methods of various embodiments to be executed on an apparatus or a computer, a non-transitory computer-readable medium including such software or commands stored thereon and executable on the apparatus or the computer.

In various exemplary embodiments of the present disclosure, the control device may be implemented in a form of hardware or software, or may be implemented in a combination of hardware and software.

Furthermore, the terms such as “unit”, “module”, etc. included in the specification mean units for processing at least one function or operation, which may be implemented by hardware, software, or a combination thereof.

In an exemplary embodiment of the present disclosure, the vehicle may be referred to as being based on a concept including various means of transportation. In some cases, the vehicle may be interpreted as being based on a concept including not only various means of land transportation, such as cars, motorcycles, trucks, and buses, that drive on roads but also various means of transportation such as airplanes, drones, ships, etc.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In exemplary embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of one or more of A and B”.

In the present specification, unless stated otherwise, a singular expression includes a plural expression unless the context clearly indicates otherwise.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

According to an exemplary embodiment of the present disclosure, components may be combined with each other to be implemented as one, or some components may be omitted.

Hereinafter, the fact that pieces of hardware are coupled operably may include the fact that a direct and/or indirect connection between the pieces of hardware is established by wired and/or wirelessly.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A system of controlling an intake rate of a vehicle blower, the system comprising:
a blower step number detection device configured to detect a current step number of a blower;
a vehicle velocity detection device configured to detect a current vehicle velocity of a vehicle;
a passenger seat seating detection device configured to detect whether a passenger is seated on a passenger seat; and
a Heating, Ventilation, and Air Conditioning (HVAC) control device electrically connected to each of the blower step number detection device, the vehicle velocity detection device, and the passenger seat seating detection device, and configured to receive passenger seat seating information from the passenger seat seating detection device, the current vehicle velocity from the vehicle velocity detection device, and the current step number of the blower from the blower step number detection device, and to determine whether an intake rate control of the blower is turned on or off according to the current step number of the blower, the current vehicle velocity, and the passenger seat seating information when the blower is turned on as the vehicle is started.

2. The system of claim 1,
wherein the step number of the blower includes a plurality of step numbers, and
wherein the HVAC control device is further configured to:
turn off an intake rate control function of the blower in response that the detected current blower step number is a predetermined step number, and
turn on the intake rate control function of the blower in response that the detected current blower step number is a step number other than the predetermined step number among the plurality of step numbers.

3. The system of claim 2,
wherein the HVAC control device includes a non-transitory computer readable storage medium,
wherein the non-transitory computer readable storage medium stores a predetermined intake rate control mapping table based on vehicle velocity information of the vehicle and a blower step number of the blower, and the intake rate control mapping table includes an intake rate control ON area and an intake rate control OFF area,
wherein the non-transitory computer readable storage medium further stores a predetermined first intake rate control switching delay time and a predetermined second intake rate control switching delay time, and
wherein the HVAC control device is further configured to:
determine whether a current intake rate control state is at the intake rate control ON area or the intake rate control OFF area based on the intake rate control mapping table according to the current vehicle velocity and the current blower step number in a state of concluding that the intake rate control function of the blower is turned on, and
determine a change of the current intake rate control state between the intake rate control ON area and the intake rate control OFF area.

4. The system of claim 3, wherein the HVAC control device is further configured to:
in response of concluding that the current intake rate control state is changed from the intake rate control ON area to the intake rate control OFF area in a state of concluding that the passenger is seated on the passenger seat, determine whether a time for which the current intake rate control state is maintained at the intake rate control OFF area is equal to or greater than the first intake rate control switching delay time,
in response that the time for which the current intake rate control state is maintained at the intake rate control OFF area is equal to or greater than the first intake rate control switching delay time, change the intake rate control to OFF, and
in response that the time for which the current intake rate control state is maintained at the intake rate control OFF area is less than the first intake rate control switching delay time, maintain the intake rate control to ON.

5. The system of claim 4, wherein the HVAC control device is further configured to:
in response of concluding that the current intake rate control state is changed from the intake rate control OFF area to the intake rate control ON area, determine whether a time for which the current intake rate control state is maintained at the intake rate control ON area is equal to or greater than the first intake rate control switching delay time,
in response that the time for which the current intake rate control state is maintained at the intake rate control ON area is equal to or greater than the first intake rate control switching delay time, change the intake rate control to ON, and
in response that the time for which the current intake rate control state is maintained at the intake rate control ON area is less than the first intake rate control switching delay time, maintain the intake rate control to OFF.

6. The system of claim 3, wherein the HVAC control device is further configured to:
in response of concluding that the current intake rate control state is changed from the intake rate control ON area to the intake rate control OFF area in a state of concluding that the passenger is not seated on the passenger seat, determine whether a time for which the current intake rate control state is maintained at the intake rate control OFF area is equal to or greater than the second intake rate control switching delay time,
in response that the time for which the current intake rate control state is maintained at the intake rate control OFF area is equal to or greater than the second intake rate control switching delay time, change the intake rate control to OFF, and
in response that the time for which the current intake rate control state is maintained at the intake rate control OFF area is less than the second intake rate control switching delay time, maintain the intake rate control to ON.

7. The system of claim 6, wherein the HVAC control device is further configured to:
in response of concluding that the current intake rate control state is changed from the intake rate control OFF area to the intake rate control ON area, determine whether a time for which the current intake rate control state is maintained at the intake rate control ON area is equal to or greater than the first intake rate control switching delay time,
in response that the time for which the current intake rate control state is maintained at the intake rate control ON area is equal to or greater than the first intake rate control switching delay time, change the intake rate control to ON, and
in response that the time for which the current intake rate control state is maintained at the intake rate control ON area is less than the first intake rate control switching delay time, maintain the intake rate control to OFF.

8. The system of claim 1,
wherein the turning on the intake rate control is to make a recirculation intake rate of the blower reach a predetermined ratio, and the predetermined ratio is 30% of a total intake amount, and
wherein the turning off the intake rate control is to make the recirculation intake rate of the blower reach 0.

9. The system of claim 2, wherein the predetermined step number is 1st step.

10. The system of claim 3, wherein the first intake rate control switching delay time is set to 10 seconds, and the second intake rate control switching delay time is set to 70 seconds.

11. A method of controlling an intake rate of a vehicle blower, the method comprising:
detecting a step number of a blower;
detecting a current vehicle velocity of a vehicle;
detecting whether a passenger is seated on a passenger seat; and
determining, by a processor, whether an intake rate control of the blower is turned on or off according to a current step number of the blower, the current vehicle velocity, and passenger seat seating information in response that the blower is turned on as the vehicle is started.

12. The method of claim 11,
wherein the step number of the blower includes a plurality of step numbers, and
wherein the method further includes:
turning off, by the processor, an intake rate control function of the blower in response that the detected current blower step number is a predetermined step number; and
turning on, by the processor, the intake rate control function of the blower in response that the detected current blower step number is a step number other than the predetermined step number among the plurality of step numbers.

13. The method of claim 12,
wherein a predetermined intake rate control mapping table is stored in a non-transitory computer readable storage medium based on vehicle velocity information and a blower step number, and the intake rate control mapping table includes an intake rate control ON area and an intake rate control OFF area, and
wherein a predetermined first intake rate control switching delay time and a predetermined second intake rate control switching delay time are stored in the non-transitory computer readable storage medium, and
wherein the method further includes:
determining, by the processor, whether a current intake rate control state is in the intake rate control ON area or the intake rate control OFF area based on the intake rate control mapping table according to the detected current vehicle velocity and the current blower step number in a state of concluding that the intake rate control function of the blower is turned on; and
determining, by the processor, a change of the current intake rate control state between the intake rate control ON area and the intake rate control OFF area.

14. The method of claim 13, further including:
in response of concluding that the current intake rate control state is changed from the intake rate control ON area to the intake rate control OFF area in a state of concluding that the passenger is seated on the passenger seat, determining, by the processor, whether a time for which the current intake rate control state is maintained at the intake rate control OFF area is equal to or greater than the first intake rate control switching delay time;
in response that the time for which the current intake rate control state is maintained at the intake rate control OFF area is equal to or greater than the first intake rate control switching delay time, changing, by the processor, the intake rate control to OFF; and
in response that the time for which the current intake rate control state is maintained at the intake rate control OFF area is less than the first intake rate control switching delay time, maintaining, by the processor, the intake rate control to ON.

15. The method of claim 14, further including:
in response of concluding that the current intake rate control state is changed from the intake rate control OFF area to the intake rate control ON area, determining, by the processor, whether a time for which the current intake rate control state is maintained at the intake rate control ON area is equal to or greater than the first intake rate control switching delay time;
in response that the time for which the current intake rate control state is maintained at the intake rate control ON area is equal to or greater than the first intake rate control switching delay time, changing, by the processor, the intake rate control to ON; and
in response that the time for which the current intake rate control state is maintained at the intake rate control OFF area is less than the first intake rate control switching delay time, maintaining, by the processor, the intake rate control to OFF.

16. The method of claim 13, further including:
in response of concluding that the current intake rate control state is changed from the intake rate control ON area to the intake rate control OFF area in a state of concluding that the passenger is not seated on the passenger seat, determining, by the processor, whether a time for which the current intake rate control state is maintained at the intake rate control OFF area is equal to or greater than the second intake rate control switching delay time;
in response that the time for which the current intake rate control state is maintained at the intake rate control OFF area is equal to or greater than the second intake rate control switching delay time, changing, by the processor, the intake rate control to OFF; and
in response that the time for which the current intake rate control state is maintained at the intake rate control OFF area is less than the second intake rate control switching delay time, maintaining, by the processor, the intake rate control to ON.

17. The method of claim 16, further including:
in response of concluding that the current intake rate control state is changed from the intake rate control OFF area to the intake rate control ON area, determining, by the processor, whether a time for which the current intake rate control state is maintained at the intake rate control ON area is equal to or greater than the first intake rate control switching delay time;
in response that the time for which the current intake rate control state is maintained at the intake rate control ON area is equal to or greater than the first intake rate control switching delay time, changing, by the processor, the intake rate control to ON; and
in response that the time for which the current intake rate control state is maintained at the intake rate control ON area is less than the first intake rate control switching delay time, maintaining the intake rate control to OFF.

18. The method of claim 11,
wherein the turning on the intake rate control is to make a recirculation intake rate of the blower reach a predetermined ratio, and the predetermined ratio is 30% of a total intake amount, and
wherein the turning off the intake rate control is to make the recirculation intake rate of the blower reach 0.

19. The method of claim 12, wherein the predetermined step number is 1st step.

20. The method of claim 13, wherein the first intake rate control switching delay time is set to 10 seconds, and the second intake rate control switching delay time is set to 70 seconds.
